(19) United States
(12) Patent Application Publication
(10) Pub. No.: US 2008/0013306 A1
(43) Pub. Date: Jan. 17, 2008

(54) Solar rechargeable flag illuminator

(76) Inventor: Ronald J. Guilmette, Salisbury, MA (US)

Correspondence Address: Ronald J. Guilmette, P.O. Box 5511, Salisbury, MA, 01952-5511, US

(21) Appl. No.: 11/486,484

(22) Filed: Jul. 14, 2006

(51) Int. Cl. F21L 4/00

(52) U.S. Cl. 362/183; 362/153; 362/431

(57) ABSTRACT

An illumination device that is mounted on the distal end of a flagpole illuminates a flag displayed during periods of darkness to conform with common flag etiquette procedures. The illumination device is powered by batteries during an illumination mode of operation during periods of darkness. The illumination device enters a charging mode of operation and charges the batteries with an embedded solar panel during periods of daylight. The illumination device is configured to attach to the flagpole using a threaded receptacle in such a way that it is easily installed in place of a flagpole finial or ornament.

### BACKGROUND OF THE INVENTION

This invention relates to the illumination of a flag displayed on a flagpole at night using a battery-powered, solar-charged illumination device.

Flag etiquette in the United States requires that the flag of the United States be ordinarily displayed between sunrise and sunset. If the flag is displayed at night, it should be illuminated. In recent years, primarily in response to the tragic events of terrorism in 2001, many Americans have displayed their patriotism by displaying the flag of the United States on flagpoles erected at their homes and places of business. Many of these patriotic Americans fly the flag 24 hours per day, each day of the year, either unaware of requirements of etiquette, or unable to provide illumination of the flag in a cost efficient and safe manner.

Typical flag illumination methods are shown in FIG. 1, where a floodlight 130 is mounted in the ground in an area immediately surrounding the base of the flagpole 100. Illumination of the flag 110 is thus provided by applying power to the flood light 130, with its beam of illumination directed up toward the flag 110.

To implement a method and apparatus for illumination of a flag on a flagpole according to the prior art, power from a nearby home or place of business must be routed on or under the ground to the floodlight 130, with automatic switching equipment installed to activate the light at sunset, and deactivate the light at sunrise. Rain that may collect in the ground in the immediate vicinity of the flagpole 100 may create a potentially hazardous environment to people and animals by exposure to the risks of electrocution. Additionally, maintenance of the area immediately surrounding the location of the floodlight 130 is necessary to keep the path of illumination free from leaves, grass, and shrubbery. Further, in Northern climates, the collection of snow in winter months can obscure the illumination of the light. Further still, the floodlight 130 requires periodic replacement of the bulbs that are prone to failure, particularly as they are installed in wet, low-lying areas.

### BRIEF SUMMARY OF THE INVENTION

The present invention relates to a method and apparatus for illuminating a flag displayed on a flagpole in a safe and cost-effective manner that conforms to the flag etiquette by illuminating the flag during periods of darkness.

More specifically, there is disclosed an illumination device that has a threaded receptacle for mounting onto the end of a flagpole that replaces the finial or ornament commonly placed to provide an aesthetic appearance to the flagpole. The illuminator of the present invention is solar-charged, generating a charge that is stored during daylight hours, and energizing an LED illuminator, or a number of LED illuminators during periods of darkness.

In an illustrative embodiment of the invention, the solar-charged illuminator has a transparent top cover and a translucent bottom cover that provides an aesthetic appearance that emulates a finial or ornament. In this embodiment, the solar-charged illuminator has a spherical shape, with both the top cover and the bottom cover are both hemispherical in shape.

### BRIEF DESCRIPTION THE SEVERAL VIEWS OF THE DRAWING

The above and further advantages of the invention may be better understood from the following detailed description, in conjunction with the following figures, referred to herein and constituting a part hereof, wherein:

FIG. 1 depicts methods and apparatus for illuminating a flag according to the prior art;

FIG. 2 depicts the distal end of a typical flagpole with a threaded receptacle for a flagpole ornament according to the background art;

FIG. 3 depicts an embodiment of the solar-charged illuminator according to the present invention;

FIG. 4 depicts an exploded view of the distal end of a typical flagpole with a threaded receptacle and the solar-charged illuminator according to the present invention;

FIG. 5 depicts a cross-sectional view of the solar-charged illuminator according to the present invention.

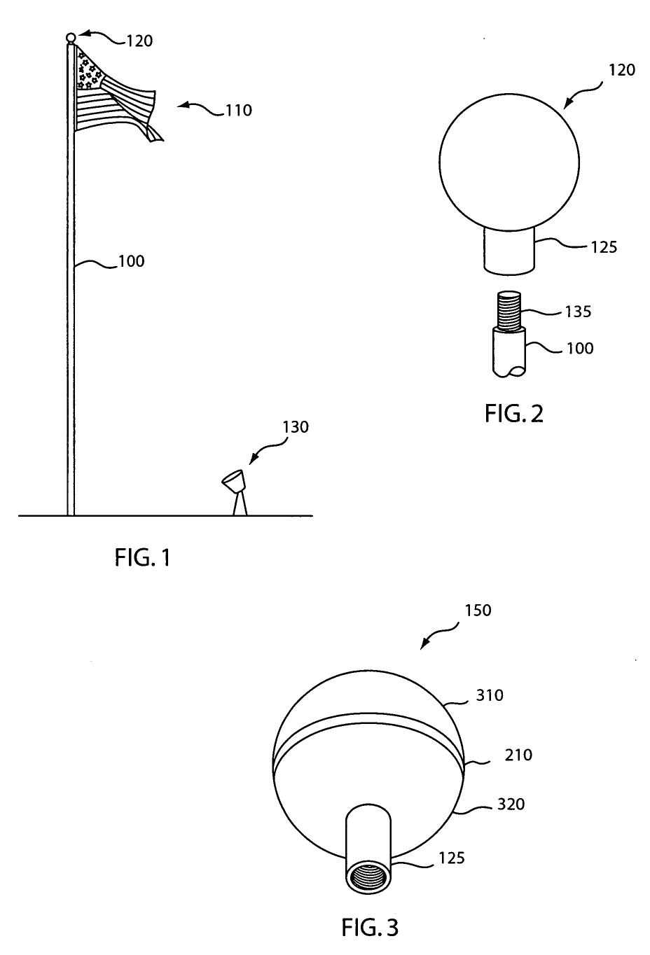

### DETAILED DESCRIPTION OF THE INVENTION

Referring to FIG. 2, the top portion of a typical flagpole 100 is shown according to the background art. The flagpole 100 has a threaded distal end 135, that is commonly provided in a ½ inch diameter with a 13NC thread, or ⅝ inch diameter with a 11NC thread. A flagpole ornament 120, also called a finial, has a threaded receptacle 125 with a diameter and thread to engage in threaded cooperation with the threaded end 135 of the flagpole 100. To provide a cost-effective, easily installed and safe illuminator for the flag, the present invention replaces the ornament 120 with a solar-charged illuminator 150 as shown in FIG. 3. As shown in FIG. 3, the solar-charged illuminator 150 has a threaded receptacle 125 with a diameter and thread to engage in threaded cooperation with the threaded end 135 of the flagpole 100.

Referring still to FIG. 3, an illustrative embodiment of the solar-charged illuminator 150 according to the present invention is shown. The solar-charged illuminator 150 has a threaded receptacle 125 that is a ½ inch diameter with a 13NC thread, or a ⅝ inch diameter with a 11NC thread to accept the threaded end of a standard flagpole. A clear or translucent bottom cover 320 permits illumination to emit from within at night, and a clear top cover 310 permits solar illumination to be collected during daylight. The bottom cover 320 and the top cover 310 are engaged into the lamp frame 210 to prevent or minimize the intrusion of water.

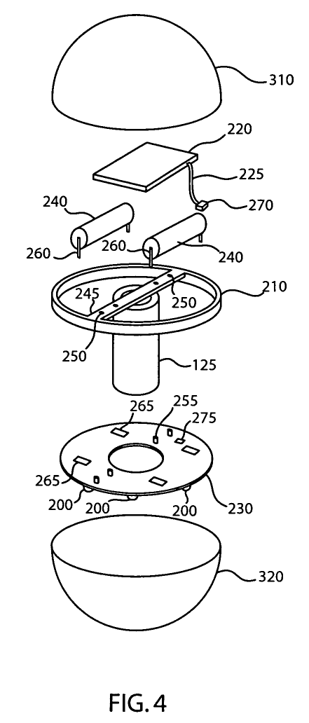

Referring to FIG. 4, an exploded view of the solar-charged illuminator 150 is shown according to the illustrative embodiment. The lamp frame 210 has an support member 245 that is fixedly attached to the threaded receptacle 125, using any number of conventional assembly methods, including screws, rivets, or spot welding. The electronics board 230 is attached to the support member 245 using board standoffs 255 that are attached to holes 250 using screws or push pins. The electronics board 230 supports the LED illuminators 200, is further described below. Storage batteries 240 are attached to the electronics board 230 using connectors 260 that engage into battery receptacles 265. The solar panel 230 is positioned on the storage batteries 240 using adhesive or epoxy. The solar panel 230 has a wire conductor pair 225 with the connector 270 that engages into the solar panel receptacle 275.

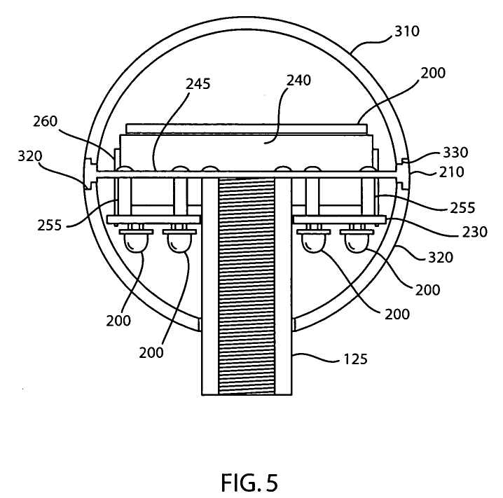

A cross-section of the illustrative embodiment of the present invention is shown in FIG. 5. The top cover 310 is molded from a transparent thermoplastic resin, and attached to the lamp frame 210 through an interlocking feature 330 molded therein. The bottom cover 320 is also molded from a thermoplastic resin, and can be transparent or preferably, translucent. The bottom cover 320 is attached to the lamp frame 210 through a similar interlocking feature 325. One skilled in the art will appreciate that a variety of methods of assembly can be used for attachment while maintaining an environment-impervious sealed assembly.

When the solar-charged illuminator 150 of the present invention is installed on the threaded distal end 135 of the flagpole 100, the top cover 310 will permit sunlight to enter the illuminator during daylight hours. The sunlight strikes the solar panel 220 to generate an electrical charge. The electronics board 230 includes various components that are interconnected to detect the electrical charge from the solar panel 220 by way of the conductor pair 225 via connector 270 and solar panel receptacle 275. When the electrical charge is detected, the electronics board operates in a charging mode where the electrical charge is used to charge the batteries 240 by way of battery connectors 260 via battery receptacles 265. In this charge mode a switch is activated so that the LED illuminators 200 are not energized. Circuitry is included to open the charging circuit if and when the batteries are fully charged so that they are not over-charged.

Upon sunset, and until the next intervening sunrise, solar illumination will not enter the top cover 310 of the solar-charged illuminator 150, and thus, the solar panel 220 will not emit an electrical charge. During this time, the electronics board operates in an illumination mode and the solar-charged illuminator 150 emits illumination to illuminate the flag 110. Circuitry in the electronics board 230 detects the electrical charge from the solar panel 220, and when it is less than a threshold value that indicates darkness. The batteries 240 are connected in parallel to drive the LED illuminators, also connected in parallel and energized by the switch. In the illustrative embodiment, twelve LED illuminators emitting white light have been shown to sufficiently illuminate a flag 110 displayed on the flagpole 100 during nighttime hours as dictated by common flag etiquette mandates.

In an embodiment of the invention, the internal components comprising the solar-charged illuminator can be obtained from a common solar-charged landscape illuminator.

One skilled in the art would appreciate that alternative embodiments are possible without departing from the spirit and scope of the invention as claimed. For example, while the top cover 310 of the illustrative embodiment provides for an aesthetic appearance that emulates an ornamental finial or ornament, the solar panel can be integrated into the surface of the top cover, as is typically done for solar-charged landscape illuminators. Accordingly, the above description is not intended to limit the invention except as indicated in the following claims.

I claim:

1. An apparatus for illumination of a flag displayed on a flagpole comprising:
a flagpole having a threaded distal end; and
a solar-charged illuminator having a receptacle threadedly engaged in the threaded distal end of the flagpole.

2. The apparatus as recited in claim 1 in which the solar-charged illuminator further comprises:
a solar panel that generates a charge when exposed to sunlight;
a battery, the battery electrically replenished by the solar panel electrical charge during daylight hours;
an illuminator coupled to the battery; and
a switch that engergizes the illuminator when the solar panel is not generating a charge.

3. The apparatus as recited in claim 2 in which the solar-charged illuminator further comprises:
a transparent top cover with the solar panel housed within;
a translucent bottom cover with the illuminator housed within.

4. The apparatus as recited in claim 3 in which both the top cover and the bottom cover are hemispherical.
